(19) United States
(12) Patent Application Publication
(10) Pub. No.: US 2015/0356383 A1
(43) Pub. Date: Dec. 10, 2015

(54) PRINTER APPARATUS, METHOD FOR CONTROLLING PRINTER APPARATUS, AND STORAGE MEDIUM

(71) Applicant: CANON KABUSHIKI KAISHA, Tokyo (JP)

(72) Inventor: Jun Horiyama, Inagi-shi (JP)

(21) Appl. No.: 14/730,817

(22) Filed: Jun. 4, 2015

(30) Foreign Application Priority Data
Jun. 6, 2014 (JP) 2014-118111

(51) Int. Cl. G06K 15/16; B65H 1/28; G06K 15/00; B65H 7/20

(52) U.S. Cl. CPC G06K 15/16; B65H 7/20; B65H 1/28; G06K 15/002

(57) ABSTRACT

A printer apparatus, which includes a sheet storage portion in which a printed product is left, displays a plurality of operation keys corresponding to each of a plurality of storage units, receives an instruction for ejecting sheets stored in a storage unit corresponding to the instruction, and changes a display form of the operation key corresponding to the storage unit in which the sheet has been stored for a predetermined time to a display form that can be distinguished from the storage unit in which the sheet has not been stored for the predetermined time.

### BACKGROUND

1. Field

Aspects of the present invention generally relate to a printer apparatus that prints an image on a sheet, a method for controlling the printer apparatus, and a storage medium.

2. Description of the Related Art

Conventionally, a printer apparatus, which prints an image on a sheet, discharges the sheet, on which the image has been printed (printed product), from the apparatus. In recent years, a mechanism of temporarily keeping the printed product in the apparatus instead of discharging the printed product right after the printing has been proposed.

A printer apparatus discussed in Japanese Patent Application Laid-Open No. 2013-220905 includes a plurality of sheet storage portions. The printed product is temporarily stored in any one of the sheet storage portions. The printer apparatus has a user authentication function. More specifically, the printed product stored in one of the plurality of sheet storage portions, which corresponds to the authenticated user, is conveyed so as to be partially exposed outside the apparatus. The user can receive the printed product by pulling out the partially exposed printed product.

With such a configuration, the printed product can be prevented from being exposed to other users, thereby preventing leakage of confidential information included in the printed product. Furthermore, printing starts before the user arrives at the installed location of the printer apparatus, whereby higher work efficiency can be achieved.

Furthermore, Japanese Patent Application Laid-Open No. 2003-191578 discusses a printer apparatus that displays a list of users corresponding to the printed products stored in the sheet storage portions. In the printer apparatus discussed in Japanese Patent Application Laid-Open No. 2003-191578, when a user name is selected by the user, a mechanism of the sheet storage portion storing the printed product corresponding to the selected user name is driven. Thus, the printed product can be removed.

In the configurations of Japanese Patent Application Laid-Open No. 2013-220905 and Japanese Patent Application Laid-Open No. 2003-191578, when the printed product remains untaken in the sheet storage portion (i.e., when the printed product has not been removed for a long period of time), the sheet storage portion is occupied by a certain user, and thus cannot be used by other users.

Japanese Patent Application Laid-Open No. 2008-173801 discusses the following technique. When the printed product remains untaken after being discharged for a predetermined period of time, a user who printed the printed product is notified of the situation through an electronic mail. However, of the plurality of sheet storage portions, the sheet storage portion which has been occupied for a long period of time cannot be determined by simply applying the configuration discussed in Japanese Patent Application Laid-Open No. 2008-173801 to the printer apparatus discussed in Japanese Patent Application Laid-Open No. 2013-220905 or Japanese Patent Application Laid-Open No. 2003-191578. In particular, it is difficult for users, other than the user who has not taken out the printed product, to recognize that there is a sheet storage portion in which the printed product remains untaken or identify the sheet storage portion which contains the untaken printed product.

### SUMMARY

Aspects of the present invention are generally directed to easily identifying a sheet storage portion in which a printed product remains untaken.

A printer apparatus according to an aspect of the present invention includes a printer unit configured to print an image on a sheet, a plurality of storage units configured to store sheets on which images are printed, a display unit configured to display a plurality of operation keys corresponding to each of the plurality of storage units and receive an instruction for ejecting a sheet stored in a corresponding storage unit corresponding to the instruction, a conveyance unit configured to convey, when any one of the plurality of operation keys is operated, the sheet stored in the storage unit corresponding to the operated operation key to a position for removing the sheet, and a change unit configured to change a display form of the operation key corresponding to the storage unit in which a sheet has been stored for a predetermined time to a display form that can be distinguished from storage units in which a sheet has not been stored for the predetermined time.

Further features of the present disclosure will become apparent from the following description of exemplary embodiments with reference to the attached drawings.

### BRIEF DESCRIPTION OF THE DRAWINGS

FIG. 1 is a cross-sectional view of a printer apparatus according to exemplary embodiments.

FIG. 2 is a cross-sectional view of sheet storage portions according to the exemplary embodiments.

FIGS. 3A and 3B are perspective views of the sheet storage portion according to the exemplary embodiments.

FIG. 4 is an outer perspective view of the printer apparatus according to the exemplary embodiments.

FIG. 5 is a hardware block diagram of a print system according to the exemplary embodiments.

FIG. 6 is a flowchart illustrating operations of the printer apparatus according to a first exemplary embodiment.

FIGS. 7A, 7B, and 7C illustrate examples of screens displayed on the printer apparatus according to the exemplary embodiments.

FIG. 8 is a flowchart illustrating operations of the printer apparatus according to the exemplary embodiments.

FIG. 9 is a flowchart illustrating operations of the printer apparatus according to the exemplary embodiments.

FIG. 10 is a flowchart illustrating operations of the printer apparatus according to a second exemplary embodiment.

### DESCRIPTION OF THE EMBODIMENTS

Exemplary embodiments are described below with reference to the drawings. The exemplary embodiments described below are not seen to be limiting. Not all the combinations of features described in the exemplary embodiments are required.

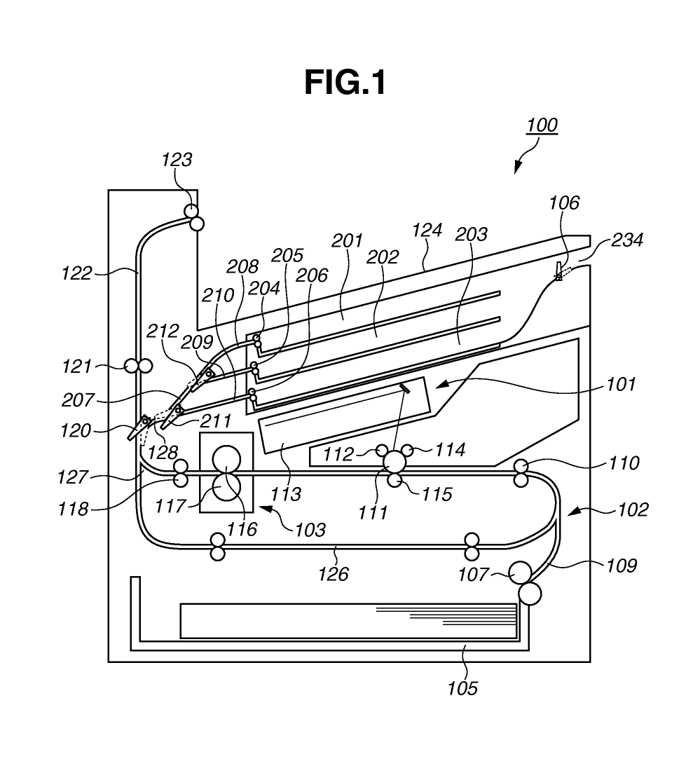

A first exemplary embodiment is described below. FIG. 1 is a cross-sectional view of a monochrome digital printer as an example of a printer apparatus of the present exemplary embodiment. FIG. 1 illustrates an entire printer apparatus 100 including a printer unit 101. A sheet conveying unit 102 conveys a sheet to the printer unit 101. A fixing unit 103 fixes an image on the sheet. A stacking portion 124 is disposed on an upper surface of the printer apparatus 100. A sheet on which an image has been printed (printed product) by the printer unit 101 is discharged onto the stacking portion 124. The printed product, which has been discharged onto the stacking portion 124, can be picked up by a user without an eject instruction described later.

The apparatus stores the sheet on which the image has been printed (printed product) by the printer unit 101 in three sheet storage portions 201, 202, and 203, which are disposed between the printer unit 101 and the stacking portion 124. When the eject instruction described below is issued, the print product, stored in the sheet storage portion 201, 202, or 203, is conveyed to be partially exposed to the outside of the apparatus so that the print product can be picked up by the user. The number of sheet storage portions, which is three in this example, may be smaller or larger than three.

The printer unit 101 includes a photosensitive drum 111 that rotates in a clockwise direction in FIG. 1 and an exposure device 113. The printer unit 101 further includes a charging roller 112, a developing device 114, and a transfer roller 115 that are arranged along a rotational direction of the photosensitive drum 111. With these components, the printer unit 101 forms a toner image on the sheet.

The sheet conveying unit 102 includes a feed cassette 105 in which a plurality of sheets to be used for printing is stacked and stored, feeding rollers 107, a conveyance guide 109, and registration rollers 110. The fixing unit 103 includes a fixing roller 116, a pressing roller 117 that is mounted on a lower side of and in contact with the fixing roller 116, and conveying rollers 118. A sheet re-conveyance path 126 which is used when an image is printed on both front and back surfaces of the sheet, is disposed between each of the printer unit 101, the fixing unit 103 and the feed cassette 105.

A conveying roller 204 conveys a sheet to the first sheet storage portion 201. Similarly, a conveying roller 205 conveys a sheet to the second sheet storage portion 202. A conveying roller 206 conveys a sheet to the third sheet storage portion 203.

A conveyance path switching member 120 can be switched between a first position illustrated in a solid line and a second position illustrated in a dotted line by an actuator (not illustrated) in FIG. 1. Reversing rollers 121 and 123 can rotate in normal and reverse directions. The sheet is discharged onto the stacking portion 124 when the reversing rollers 121 and 123 rotate in the normal direction. The sheet is conveyed to the re-conveyance path 126 when the reversing rollers 121 and 123 rotate in the reverse direction

The conveyance path switching member 120 is switched to the dotted line position to convey the sheet to the stacking portion 124. Then, the sheet is conveyed by the conveying rollers 121 along the discharge guide 122, and then is discharged onto the stacking portion 124 by the reversing rollers 123.

When an image is to be printed on both sides of the sheet, the sheet, having the toner image fixed on one side (surface), is conveyed to the reversing rollers 123. Then, when a trailing end of the sheet passes through a branch portion 127, the conveying rollers 121 and the reversing rollers 123 are rotated in reverse directions, whereby the sheet is switched back to be re-conveyed to the printer unit 101 through the re-conveyance path 126.

The conveyance path switching member 120 is switched to the solid line position to convey the sheet to the sheet storage portion 201, 202, or 203. Thus, the sheet is conveyed to the sheet storage portion 201, 202, or 203 through a conveyance path 128. First and second switching members 211 and 212 switch a path through which the sheet is conveyed. Each of the first switching member 211 and the second switching member 212 is configured to be switchable between a solid line position and a dotted line position by an actuator (not illustrated) in FIG. 1.

The first switching member 211 and the second switching member 212 are each switched to and held at the solid line position in FIG. 1, to convey the sheet to the first sheet storage portion 201. Then, the sheet, on which the image has been printed, passes through the conveyance path 128 and the conveyance guides 207 and 208 in this order, and then is conveyed by the conveying rollers 204 to be stored in the first sheet storage portion 201 in a facedown state, that is, the surface on which the toner image is printed faces downward.

The first switching member 211 is switched to and held at the solid line position and the second switching member 212 is switched to and held at the dotted line position in FIG. 1 to convey the sheet to the second sheet storage portion 202. Then, the sheet, on which the image is printed, passes through the conveyance path 128 and the conveyance guides 207 and 209 in this order, and then is conveyed by the conveying rollers 205 to be stored in the second sheet storage portion 202 in the facedown state, that is, the surface on which the toner image is printed faces downward.

The first switching member 211 is switched to and held at the dotted line position in FIG. 1 to convey the sheet to the third sheet storage portion 203. Then, the sheet, on which the image is printed, passes through the conveyance path 128 and the conveyance guide 210 in this order, and then is conveyed by the conveying rollers 206 to be stored in the third sheet storage portion 203 in the facedown state, that is, the surface on which the toner image is printed faces downward.

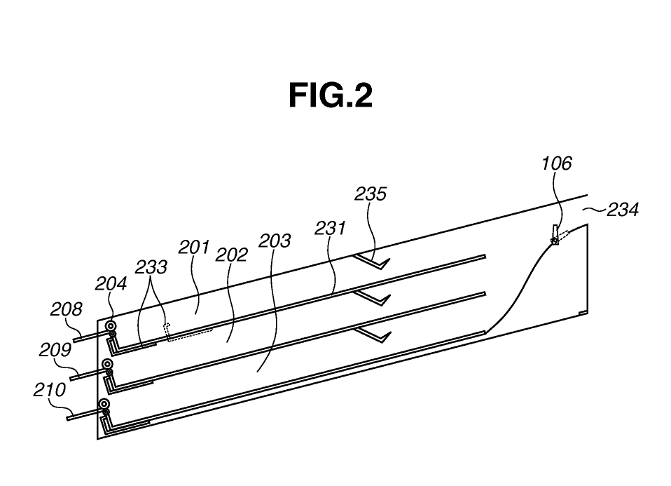

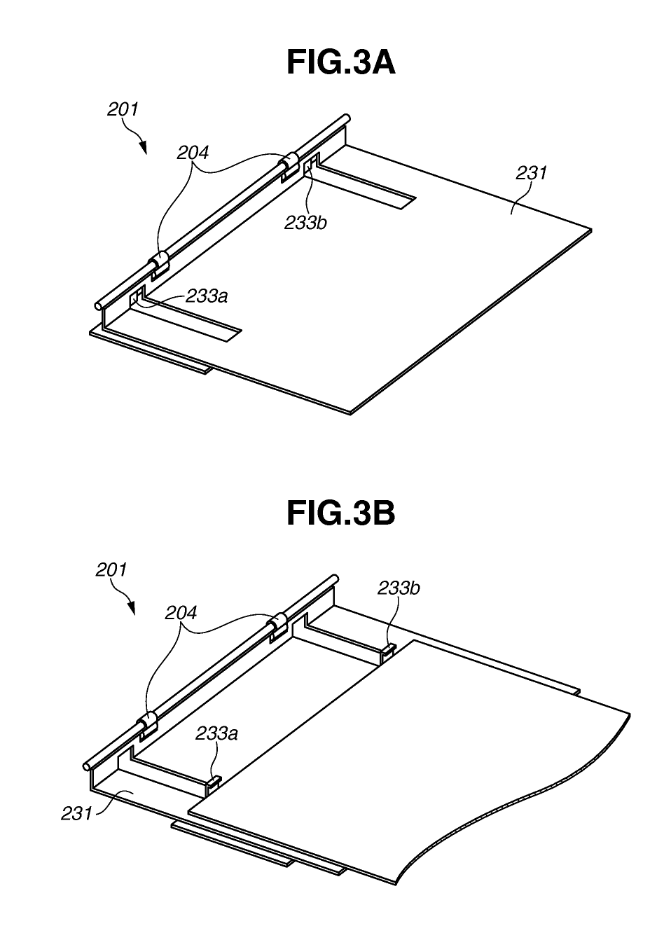

The sheet stored in the sheet storage portion 201, 202, or 203 is conveyed to a discharge port 234 in response to the eject instruction from the user, in a way described below in detail with reference to FIGS. 2 and 3. The sheet conveyed to the discharge port 234 is kept in a state of being partially exposed to the outside of the apparatus, to be later pulled out by the user. A member 106 detects that the sheet conveyed to the discharge port 234 is pulled out by the user. The member 106 is at a solid line portion in FIG. 1 before the sheet is conveyed to the discharge port 234 or after the conveyed sheet is pulled out by the user. The member 106 is at a dotted line position when the sheet is conveyed to the discharge port 234 and waits to be pulled out by the user. In the present example, a single common discharge port 234 is provided for the sheet storage portions 201, 202, and 203. Alternatively, a dedicated discharge port may be provided in each of the sheet storage portions.

Now, the sheet storage portions 201, 202, and 203 are described in detail with reference to FIG. 2. The printer apparatus 100 includes the plurality of sheet storage portions 201, 202, and 203 stacked one on top of the other. The sheet storage portions have the same configuration, and here, the configuration of the first sheet storage portion 201 is described.

The sheet conveyed by the conveying rollers 204 to the first sheet storage portion 201 is temporarily stacked on a stacking surface 231 to be stored. A sheet presence/absence detection unit (not illustrated) can detect whether the sheet is placed on the stacking surface 231 (or whether there is a vacant sheet storage portion). A pushing member 233 pushes out an edge portion of the stored sheet on an upstream side in the conveyance direction (trailing edge portion) so that an edge portion of the sheet on a downstream side in the conveyance direction (leading edge portion) is partially exposed to the outside of the apparatus through the discharge port 234. The user can pull out the sheet pushed out by the pushing member 233 to the discharge port 234. Here, a length of the portion of the sheet exposed to the outside by the pushing member 233 is 30 mm. However, any length can be employed as long as the sheet can be grabbed by the user and does not fall off under its own weight.

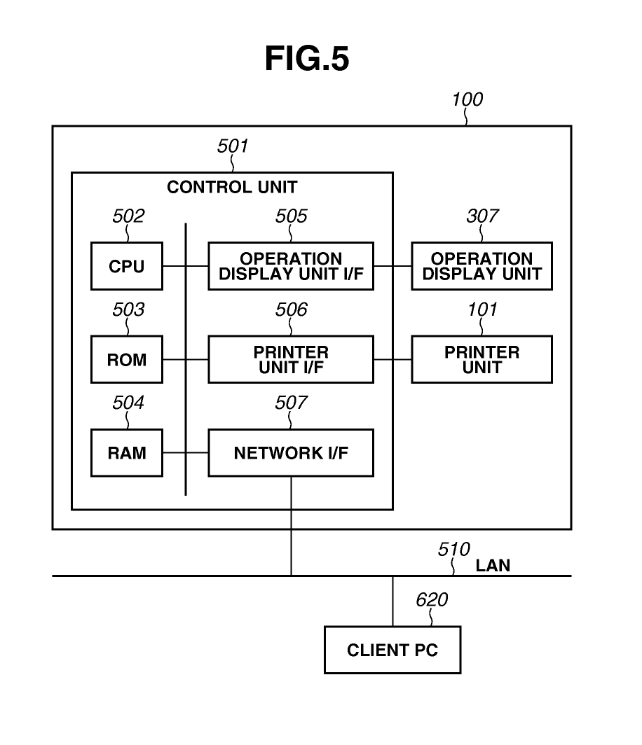

The number of sheets and the sizes of the sheet that can be stored in the sheet storage portions 201, 202, and 203 of the printer apparatus 100 are limited. More specifically, only 15 sheets of normal paper can be stored in a single sheet storage portion at a maximum. Whether the sheets are fully stacked in the sheet storage portion is detected by a full-state detection lever 235. The sheet storage capacity might be smaller when sheets are thicker than the normal paper. The inclination of the full-load state detection lever 235 changes when the sheet storage portion reaches a full load state. A photointerrupter detects the change and inputs a signal indicating the detection result to a control unit 501 that is illustrated in FIG. 5 and described below.

When the sheet is stored in the first sheet storage portion 201, the pushing member 233 is positioned at a stacking position that is illustrated in a solid line in FIG. 2 and does not hamper the conveying and stacking of sheets. When the stored sheet is pushed out, the pushing member 233 moves toward the discharge port 234 along a sheet discharge direction, to move to a pushing-out position (sheet discharge position) illustrated in a dotted line. Then, when the member 106 detects that the sheet has been pulled out by the user, the pushing member 233 returns to the stacking position.

FIGS. 3A and 3B are perspective views of the sheet storage portion 201. FIG. 3A illustrates a state where the pushing member 233 is at the stacking position. FIG. 3B illustrates a state where the pushing member 233 is at the pushing position. The pushing member 233 includes two trailing edge pressing claws 233a and 233b arranged in a sheet width direction. The trailing edge pressing claws 233a and 233b prevent the sheet from curling when the sheet is discharged. When the sheet is pushed out, the sheet is discharged with an upstream end portion pressed by the trailing edge pressing claws 233a and 233b. The pushing member 233 moves back and forth in the sheet discharge direction between the stacking position and the pushing position.

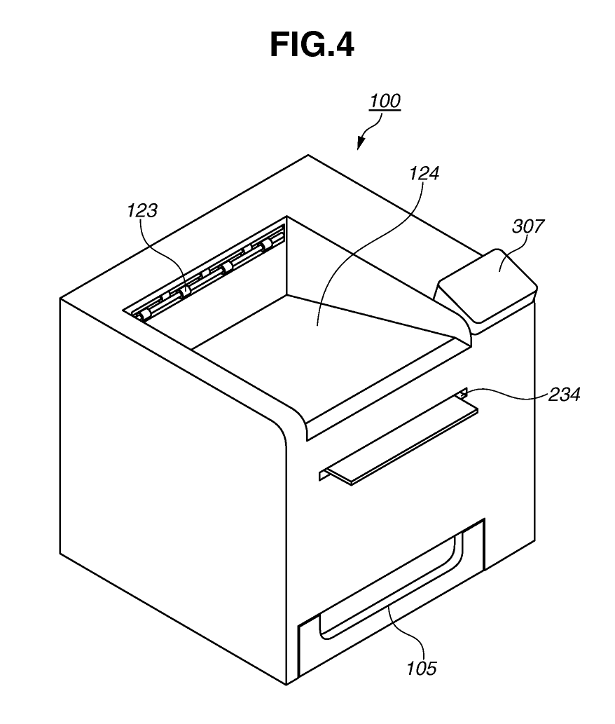

FIG. 4 is an outer perspective view of the printer apparatus 100. A downstream edge of a stack of sheets discharged from any one of the sheet storage portions 201, 202, or 203 is exposed from the discharge port 234. The user can receive his or her printed product by grabbing the downstream edge exposed to the outside of the printer apparatus 100 and pulling out the stack of sheets. An operation display unit 307 can display a screen for receiving from the user an instruction to the printer apparatus 100 and notifying the user of various types of information. The operation display unit 307 has a touch panel function. The control unit 501 described below determines the content of the instruction from the user in accordance with the touched position.

FIG. 5 is a hardware configuration diagram of the printer apparatus 100. The control unit 501 includes a central processing unit (CPU) 502 and controls operation of the printer apparatus 100 as a whole. The CPU 502 reads out a control program stored in a read only memory (ROM) 503 and controls a printing operation and sheet conveyance. A random access memory (RAM) 504 is used as a main memory or a temporary storage area such as a work area for the CPU 502. Here, an example is described where a single CPU 502 executes each operation in flowcharts described below by using a single memory (RAM 504). Alternatively, other configurations may be employed. For example, a plurality of CPUs and a plurality of RAMs may cooperate to execute each operation.

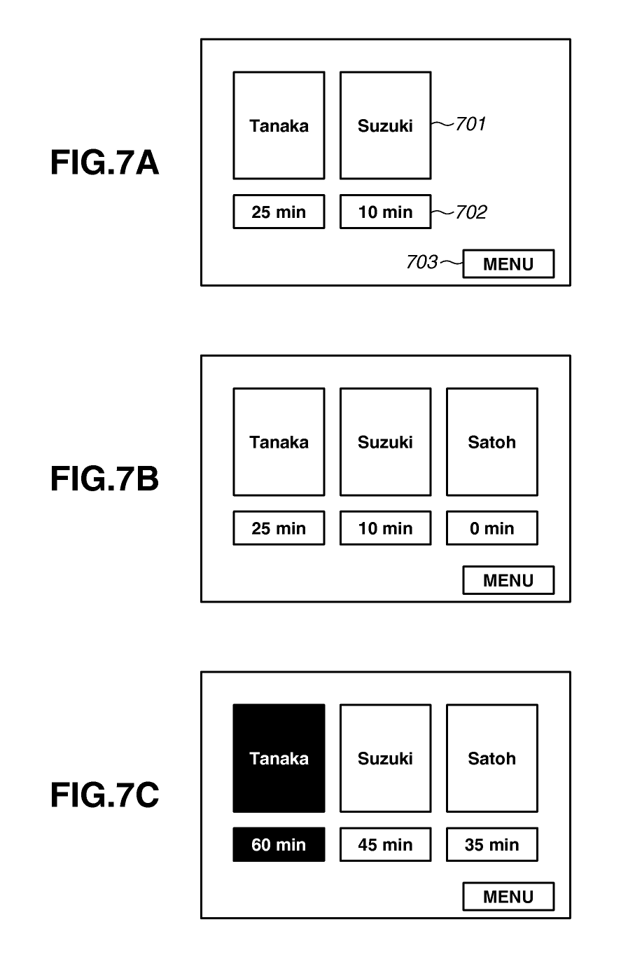

An operation display unit I/F 505 connects the operation display unit 307 and the control unit 501. The operation display unit 307 serves as a reception unit for receiving the instruction for ejecting the printed product described below, and displays a screen illustrated in FIG. 7.

A printer unit I/F 506 connects the printer unit 101 to the control unit 501. An image to be printed by the printer unit 101 is transferred from the control unit 501 through the printer unit I/F 506, and is printed on the sheet by the printer unit 101.

A network I/F 507 connects the printer apparatus 100 to a local area network (LAN) 510. A client PC 620 is connected to the LAN 510. The network I/F 507 receives a print job generated by a printer driver installed in the client PC 620.

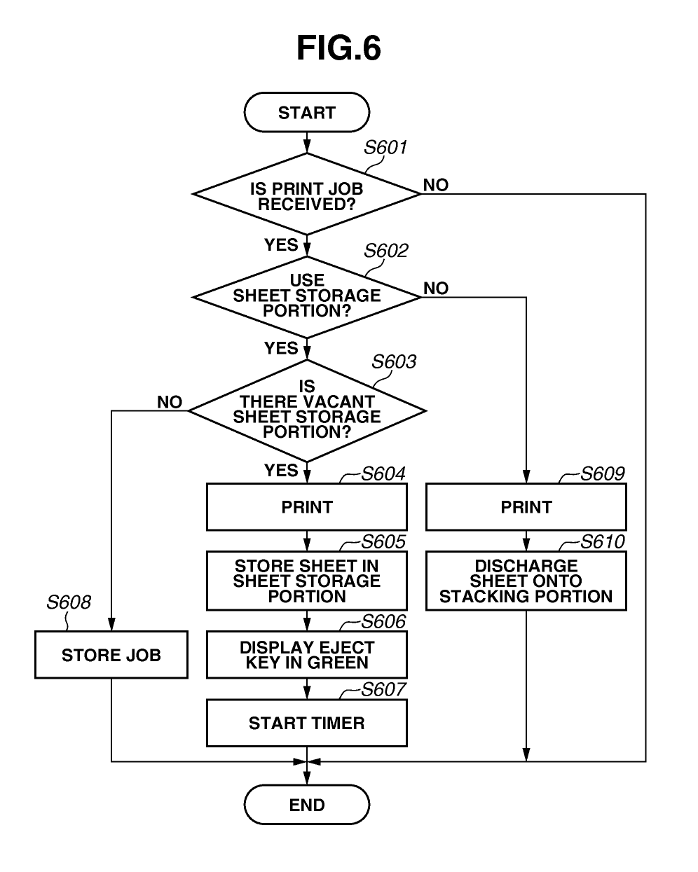

FIG. 6 is a flowchart illustrating operations of the printer apparatus 100 performed when the print job is received from the client PC 620. The operations (steps) illustrated in the flowchart in FIG. 6 are implemented when the control unit 501 of the printer apparatus 100 executes the control program stored in the ROM 503. Processing in the flowchart in FIG. 6 is constantly executed (once the processing is executed from the start to the end, the processing is restarted with substantially no interval).

In step S601, the control unit 501 determines whether the print job is received. The processing proceeds to step S602 when the control unit 501 determines that the print job is received (Yes in step S601), and is terminated when the control unit 501 determines that the print job is not received (No in step S601).

In step S602, the control unit 501 determines whether the sheet storage portion is to be used (whether the received print job includes a setting of using the sheet storage portion). The processing proceeds to step S603 when the control unit 501 determines that the sheet storage portion is to be used (Yes in step S602), and proceeds to step S609 when the control unit 501 determines that the sheet storage portion is not to be used (No in step S602). In step S609, the control unit 501 prints an image based on the print job on the sheet, and in step S610, the control unit 501 discharges the printed sheet onto the stacking portion 124.

In step S603, the control unit 501 determines whether there is a vacant sheet storage portion. The control unit 501 determines that there is a vacant sheet storage portion when any one of the sheet storage portions 201, 202, and 203 includes no sheet. The processing proceeds to step S604 when the control unit 501 determines that there is a vacant sheet storage portion (Yes in step S603), and proceeds to step S608 when the control unit 501 determines that there is no vacant sheet storage portion (No in step S603). In step S608, the control unit 501 stores the received print job in the RAM 504, and the processing is terminated.

In step S604, the control unit 501 prints the image based on the print job on the sheet, and in the subsequent step S605, the control unit 501 stores the printed sheet in the sheet storage portion, which is the sheet storage portion determined to be vacant in step S603. When a plurality of sheet storage portions is vacant, the sheet storage portion to be used is determined based on a priority. The priority is set to be the highest to the sheet storage portion 201, the second highest to the sheet storage portion 202, and the lowest to the sheet storage portion 203.

In step S606, an eject key for receiving the instruction for ejecting the sheet stored in the sheet storage portion, from the user is displayed in green. The eject key is displayed, on a screen displayed on the operation display unit 307, while being associated with the corresponding sheet storage portion.

FIG. 7 illustrates an example of the screen for receiving the eject instruction. The screen illustrated in FIG. 7 is displayed on the operation display unit 307. FIG. 7A illustrates a state in which a sheet of a user named [Tanaka] is stored in the sheet storage portion 201 and a sheet of a user named [Suzuki] is stored in the sheet storage portion 202. The name of the user is displayed in a display object 701. Alternatively, a portrait picture of each user may be registered in advance, and the portrait picture of the corresponding user may be displayed in the display object 701.

Information indicating a time elapsed after the sheet is stored in each sheet storage portion is displayed on a display object 702. Here, the display objects 701 and 702 are collectively referred to as the eject key (an operation key for receiving the eject instruction). Alternatively, only the display object 701 may be referred to as the eject key. The user can issue an instruction to eject the sheet by operating (pressing) the eject key. A display object 703 is an operation key for displaying a menu screen. When the display object 703 is operated (pressed), a menu screen (not illustrated) is displayed. The eject key corresponding to the sheet storage portion 203 is not displayed, because the sheet storage portion 203 stores no sheet.

The printer apparatus 100 is configured to change a display mode of the eject key when the sheet stored in the sheet storage portion remains untaken (when the sheet has not been taken out for a predetermined time). More specifically, the display objects 701 and 702 are displayed in green for 60 minutes after the sheet is stored in the sheet storage portion. After 60 minutes elapses, the display color changes to red. Thus, when the user issues the instruction to eject the sheet, the user can easily recognize whether there is a sheet storage portion in which the sheet remains untaken, and can easily recognize the sheet storage portion in which the sheet remains untaken. In this example, both of the display objects 701 and 702 change to red. Alternatively, when the portrait picture of the user is displayed in the display object 701, only the display object 702 may be changed.

When, in the state illustrated in FIG. 7A, the sheet of a user named [Satoh] is newly stored in the sheet storage portion 203, the screen is updated as illustrated in FIG. 7B. In step S607, a timer for counting the time elapsed after the sheet is stored in the sheet storage portion, is started. Here, three timers, respectively associated with the sheet storage portion 201, 202, and 203, are provided. However, different configurations are feasible. For example, a single clock indicating the current time may be provided. Thus, the time, at which the sheet is stored, may be stored for each sheet storage portion, and the elapsed time may be determined based on the difference between the stored time and the current time.

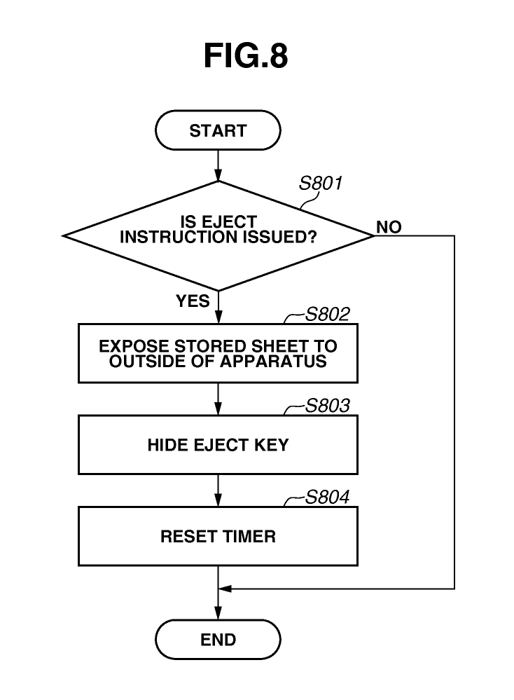

FIG. 8 is a flowchart illustrating operations in the printer apparatus 100 in a case where the user takes out the sheet stored in the sheet storage portion. The operations (steps) illustrated in the flowchart in FIG. 8 are implemented when the control unit 501 of the printer apparatus 100 executes the control program stored in the ROM 503. Processing in the flowchart in FIG. 8 is continuously executed (Once the processing is executed from the start to the end, the processing is restarted with substantially no interval).

In step S801, the control unit 501 determines whether the eject instruction has been issued from the user (whether the eject key has been operated in the screen illustrated in FIG. 7). The processing proceeds to step S802 when the control unit 501 determines that the user has issued the eject instruction (Yes in step S801), and is terminated when the control unit 501 determines that the user has not issued the eject instruction (No in step S801).

In step S802, the control unit 501 causes the pushing member 233 to convey the printed product stored in the sheet storage portion corresponding to the operated eject key, so that the printed product is exposed to the outside of the printer apparatus 100 through the discharge port 234. The user can receive the printed product by grabbing and pulling out the exposed portion. The printer apparatus 100 may perform user authentication after the eject key is operated. More specifically, the printer apparatus 100 may request the user to input a user ID and a password, and check the user ID and the password with user information stored in advance. In this case, the sheet is conveyed when the authentication is successful. In step S803, the control unit 501 hides the operated eject key (so as not to be displayed). In step S804, the control unit 501 resets the timer. After step S804, the control unit 501 may determine whether there is a print job stored in the RAM 504. If there is a print job stored in the RAM 504, the processing may proceed to step S604 after the sheet exposed in step S802 is pulled out by the user.

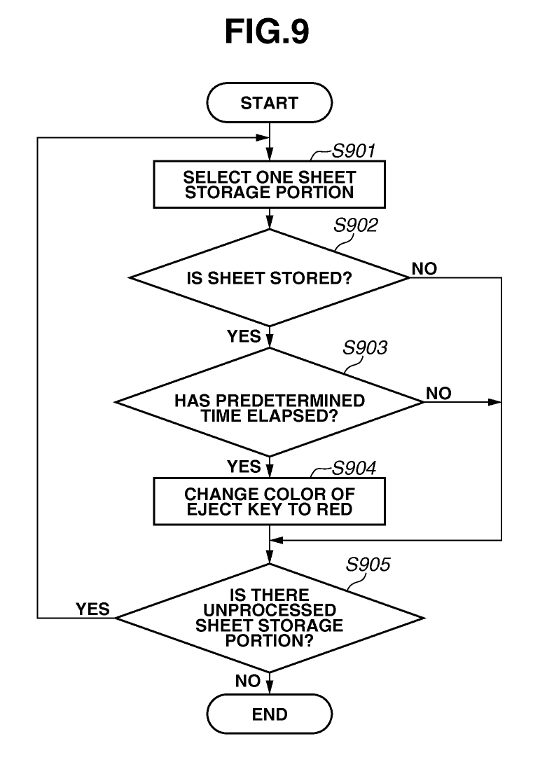

FIG. 9 is a flowchart illustrating operations in the printer apparatus 100 in a case where the sheet stored in the sheet storage portion has not been taken out for a long period of time. The operations (steps) illustrated in the flowchart in FIG. 9 are implemented when the control unit 501 of the printer apparatus 100 executes the control program stored in the ROM 503. Processing in the flowchart in FIG. 9 is constantly executed (Once the processing is executed from the start to the end, the processing is restarted with substantially no interval).

In step S901, the control unit 501 selects one sheet storage portion. In step S902, the control unit 501 determines whether the sheet is stored in the sheet storage portion selected in step S901. The processing proceeds to step S903 when the control unit 501 determines that the sheet is stored (Yes in step S902), and proceeds to step S905 when the control unit 501 determines that the sheet is not stored (No in step S902).

In step S903, the control unit 501 determines whether a predetermined time has elapsed after the sheet is stored in the sheet storage portion. The processing proceeds to step S904 when the control unit 501 determines that the predetermined time has elapsed (Yes in step S903), and proceeds to step S905 when the control unit 501 determines that the predetermined time has not elapsed (No in step S903). In step S904, the display color of the eject key is changed from green to red.

FIG. 7C illustrates a screen displayed when 60 minutes have elapsed with no eject instruction issued after the sheet is stored in the sheet storage portion 201. As illustrated in the figure, the color of the eject key on which the name [Tanaka] is displayed is changed to red (colored in black in the figure). The other two eject keys remain being displayed in green because 60 minutes have not elapsed yet.

In step S905, the control unit 501 determines whether there is an unprocessed sheet storage portion. The processing returns to step S901 when the control unit 501 determines that there is an unprocessed sheet storage portion (Yes in step S905). The processing is terminated when the control unit 501 determines that there is no unprocessed sheet storage portion (No in step S905).

As described above, in the first exemplary embodiment, the eject key is displayed in green when the sheet is stored in the sheet storage portion. The display color of the eject key changes from green to red when the sheet has not been taken out for a predetermined time. Thus, the user can easily recognize whether there is a sheet storage portion in which the sheet remains untaken, and can easily identify the sheet storage portion in which the sheet remains untaken. In the example described above, the display color of the eject key changes from green to red. Alternatively, the display mode may be changed in any other way as long as the sheet storage portion, in which the sheet remains untaken, can be distinguished from the sheet storage portion, in which no sheet remains untaken. For example, the design of an icon, which represents the eject key, may be changed, or the size or the display position of the eject key may be changed.

A second exemplary embodiment will be described below. In the first exemplary embodiment, an example is described where the print job, including the setting for using the sheet storage portion, is not executed but stored when there is no vacant sheet storage portion. On the other hand, in the second exemplary embodiment, even when there is no vacant sheet storage portion, if there is a sheet storage portion storing the sheet of the user corresponding to the received print job, the sheet is additionally stored in that sheet storage portion. Only those elements that differ from the first exemplary embodiment will be described below and the description of any similar elements will be omitted.

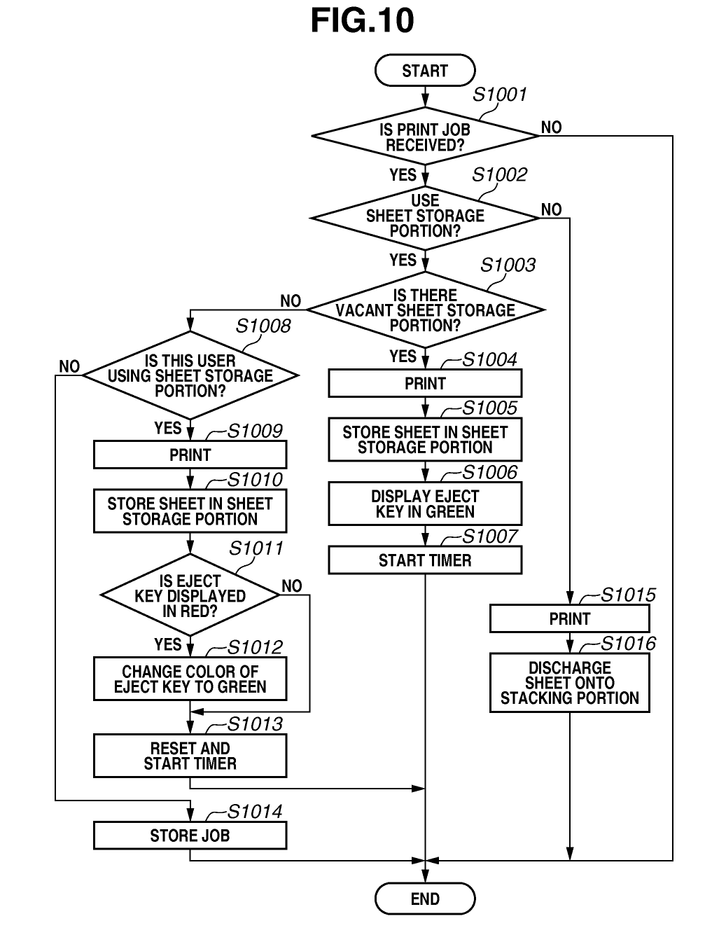

FIG. 10 corresponds to the flowchart in FIG. 6 according to the first exemplary embodiment. FIG. 10 is a flowchart illustrating operations of the printer apparatus 100 performed when the print job is received from the client PC 620. The operations (steps) illustrated in the flowchart in FIG. 10 are implemented when the control unit 501 of the printer apparatus 100 executes the control program stored in the ROM 503.

In step S1001, the control unit 501 determines whether the print job is received. The processing proceeds to step S1002 when the control unit 501 determines that the print job is received (Yes in step S1001), and is terminated when the control unit 501 determines that the print job is not received (No in step S1001).

In step S1002, the control unit 501 determines whether the sheet storage portion is to be used (whether the received print job includes the setting for the sheet storage portion). The processing proceeds to step S1003 when the control unit 501 determines that the sheet storage portion is to be used (Yes in step S1002), and proceeds to step S1015 when the control unit 501 determines that the sheet storage portion is not to be used (No in step S1002). In step S1015, the control unit 501 prints the image based on the print job on a sheet. In step S1016, the control unit 501 discharges the printed sheet onto the stacking portion 124.

In step S1003, the control unit 501 determines whether there is a vacant sheet storage portion. The control unit 501 determines that there is a vacant sheet storage portion when any one of the sheet storage portions 201, 202, or 203 includes no sheet. The processing proceeds to step S1004 when the control unit 501 determines that there is a vacant sheet storage portion (Yes in step S1003), and proceeds to step S1008 when the control unit 501 determines that there is no vacant sheet storage portion (No in step S1003).

In step S1008, the control unit 501 determines whether there is a sheet storage portion that has been used by the user corresponding to the received print job. The processing proceeds to step S1009 when the control unit 501 determines that there is a sheet storage portion that has been used by the corresponding user (Yes in step S1008), and proceeds to step S1014 when the control unit 501 determines that there is no sheet storage portion that has been used by the corresponding user (No in step S1008). In step S1014, the control unit 501 stores the received print job in the RAM 504, and the processing is terminated.

In step S1004, the control unit 501 prints the image based on the print job on the sheet, and in the subsequent step S1005, the control unit 501 stores the printed sheet in the sheet storage portion, which is determined to be vacant in step S1003. When a plurality of sheet storage portions is vacant, the sheet storage portion to be used is determined based on a priority. The priority is set to be the highest to the sheet storage portion 201, the second highest to the sheet storage portion 202, and the lowest to the sheet storage portion 203.

In step S1006, the control unit 501 displays an eject key for receiving the eject instruction, for the sheet stored in the sheet storage portion, from the user in green.

In step S1007, the control unit 501 starts the timer for counting the time elapsed after the sheet is stored in the sheet storage portion. In this example, three timers, respectively associated with the sheet storage portion 201, 202, and 203, are provided. However, different configurations are feasible. For example, a single clock indicating the current time may be provided. The time at which the sheet is stored may be stored for each sheet storage portion, and the elapsed time may be determined based on the difference between the stored time and the current time.

In step S1009, the control unit 501 prints the image based on the print job on the sheet, and in the subsequent step S1010, the control unit 501 stores the sheet after the printing is made in the sheet storage portion, which is the sheet storage portion determined to be used by the corresponding user in step S1008. When a plurality of sheet storage portions is determined to be used by the corresponding user, the sheet storage portion to be used is determined based on a priority. The priority is set to be the highest to the sheet storage portion 201, the second highest to the sheet storage portion 202, and the lowest to the sheet storage portion 203.

In step S1011, the control unit 501 determines whether the eject key, corresponding to the sheet storage portion in which the sheet is stored in step S1010, is currently displayed in red (whether a predetermined time has elapsed after the sheet is stored). The processing proceeds to step S1012 when the control unit 501 determines that the eject key is currently displayed in red (Yes in step S1011), and proceeds to step S1013 when the control unit 501 determines that the eject key is not currently displayed in red (No in step S1011). In step S1012, the displayed color of the eject key is changed to green. In step S1013, the timer is reset and then is restarted.

The user may set whether to execute the operations in steps S1011 to S1013. When the user sets not to execute the operations in steps S1011 to S1013, the elapsed time counted after the sheet is first stored is not reset even if the sheet is additionally stored in step S1010. Thus, the eject key continues to be displayed in red when the time elapsed after the sheet is first stored exceeds the predetermined time.

As described above, in the second exemplary embodiment, even when there is no vacant sheet storage portion, if there is a sheet storage portion storing the sheet of the user corresponding to the received print job, the sheet is additionally stored in that sheet storage portion. When the sheet is additionally stored, the counted elapsed time is reset, and the color of the eject key displayed in red is changed to the original color which is green.

The above-described exemplary embodiments are also achieved by executing the following processing. Specifically, a storage medium storing therein a program code of software implementing the functions of the exemplary embodiments above may be supplied to a system or an apparatus, and a computer (or a CPU, a microprocessor unit (MPU), or the like) of the system or the apparatus reads out the program code stored in the storage medium.

In such a case, the functions of the exemplary embodiments described above are implemented by the program code readout from the storage medium, whereby the program code and the storage medium storing the program code constitute the above-described exemplary embodiments.

According to the present disclosure, a sheet storage portion in which a printed product remains untaken can be easily identified.

### Other Embodiments

Additional embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-118111, filed Jun. 6, 2014, which is hereby incorporated by reference herein in its entirety.

What is claimed is:

1. A printer apparatus comprising:
a printer unit configured to print an image on a sheet;
a plurality of storage units configured to store sheets on which images are printed;
a display unit configured to display a plurality of operation keys corresponding to each of the plurality of storage units and receive an instruction for ejecting a sheet stored in a storage unit corresponding to the instruction;
a conveyance unit configured to convey, when any of the plurality of operation keys is operated, the sheet stored in the storage unit corresponding to the operated operation key to a position for removing the sheet; and
a change unit configured to change a display form of the operation key corresponding to the storage unit in which a sheet has been stored for a predetermined time to a display form that can be distinguished from storage units in which a sheet has not been stored for the predetermined time.

2. The printer apparatus according to claim 1, further comprising a holding unit configured to hold the sheet in a state where the sheet stored in the storage unit is partially exposed outside of the printer apparatus,
wherein the conveyance unit is configured to convey, when any of the plurality of operation keys is operated, the sheet stored in the storage unit corresponding to the operated operation key to a position to be held by the holding unit.

3. The printer apparatus according to claim 1, wherein the change unit is configured to change a color of a display object corresponding to each of the plurality of operation keys.

4. The printer apparatus according to claim 3, wherein the display object includes information indicating time elapsed after the sheet is stored.

5. The printer apparatus according to claim 1, wherein the display unit is configured to display the operation key corresponding to the storage unit storing the sheet and not to display the operation key corresponding to the storage unit not storing the sheet.

6. The printer apparatus according to claim 1, wherein after the change unit changes the display form of the operation key, the change unit restores the display form of the operation key to an original form when the sheet is newly stored in the storage unit corresponding to the operation key.

7. The printer apparatus according to claim 6, further comprising:
a determination unit configured to determine, when a print job is received, whether there is a storage unit used by a user the same as a user corresponding to the print job; and
a control unit configured to store the sheet on which the image based on the received print job has been printed as the newly stored sheet when the determination unit determines that there is a storage unit used by the user the same as the user corresponding to the received print job.

8. The printer apparatus according to claim 1, further comprising an authentication unit configured to perform user authentication when the operation key is operated,
wherein the conveyance unit is configured to convey the sheet when the user authentication by the authentication unit succeeds.

9. A method for controlling a printer apparatus that includes a printer unit configured to print an image on a sheet and a plurality of storage units configured to store the sheet, the method comprising:
displaying a plurality of operation keys corresponding to each of the plurality of storage units;
receiving an instruction for ejecting a sheet stored in a storage unit corresponding to the instruction;
conveying, when any of the plurality of operation keys is operated, the sheet stored in the storage unit corresponding to the operated operation key to a position where the sheet can be removed; and
changing a display form of the operation key corresponding to the storage unit in which a sheet has been stored for a predetermined time to a display form that can be distinguished from storage units in which a sheet has not been stored for the predetermined time.

10. A non-transitory computer-readable storage medium storing computer executable instructions that cause a computer to perform a method for controlling a printing apparatus that includes a printer unit configured to print an image on a sheet and a plurality of storage units configured to store the sheet, the method comprising:
displaying a plurality of operation keys corresponding to each of the plurality of storage units;
receiving an instruction for ejecting a sheet stored in a storage unit corresponding to the instruction;
conveying, when any of the plurality of operation keys is operated, the sheet stored in the storage unit corresponding to the operated operation key to a position where the sheet can be removed; and
changing a display form of the operation key corresponding to the storage unit in which a sheet has been stored for a predetermined time to a form that can be distinguished from storage units in which a sheet has not been stored for the predetermined time.
